(19) United States
(12) Patent Application Publication
(10) Pub. No.: US 2016/0286464 A1
(43) Pub. Date: Sep. 29, 2016

(54) Method for Filtering Uplink Data Based on the Characteristic of a Logical Bearer

(71) Applicant: Telefonaktiebolaget L M Ericsson (publ), Stockholm (SE)

(72) Inventors: Henning Wiemann, Aachen (DE); Hakan Palm, Vaxjo (SE); Riikka Susitaival, Helsinki (FI)

(21) Appl. No.: 14/778,024

(22) PCT Filed: Mar. 17, 2014
(86) PCT No.: PCT/SE2014/050319

§ 371 Date: Sep. 17, 2015

Related U.S. Application Data
(60) Provisional application No. 61/803,583, filed on Mar. 20, 2013.

(51) Int. Cl. H04W 48/06; H04W 76/04; H04W 72/04

(52) U.S. Cl. CPC H04W 48/06; H04W 72/0413; H04W 76/046

(57) ABSTRACT

The present disclosure relates to methods and devices for filtering uplink data in a radio communication system. The present disclosure more specifically relates to a method performed in a radio device 100. The method comprises receiving, over a radio interface, a message comprising at least one barring parameter associated with a characteristic of a logical bearer 30 between the radio device and a core network 300. The method also comprises determining that an uplink data packet is associated with the characteristic of the logical bearer. The method also comprises determining, based at least on the barring parameter, whether access for transmitting the UL data packet 10 over the radio interface is allowed.

### TECHNICAL FIELD

The present disclosure relates to methods and devices for filtering uplink data in a radio communication system.

### BACKGROUND

In a typical cellular radio system, wireless terminals (also known as radio devices, mobile stations and/or user equipments (UEs)) communicate via a radio access network (RAN) to one or more core networks (CN). The wireless terminals can be mobile stations or user equipments (UE) such as mobile telephones (cellular telephones) and laptops with wireless capability (e.g., mobile termination), and thus can be, for example, portable, pocket, hand-held, computer-included, or car-mounted mobile devices which communicate voice and/or data via radio access network.

The radio access network (RAN) covers a geographical area which is divided into cell areas, with each cell area being served by a base station, e.g., a radio base station (RBS), which in some networks is also called a Node B (NB) or evolved Node B (eNode B or eNB). A cell is a geographical area where radio coverage is provided by the radio base station equipment at a base station site. Each cell is identified by an identity within the local radio area, which is broadcast in the cell. The base stations communicate over the air interface operating on radio frequencies with the user equipments (UE) within range of the base stations.

In some versions (particularly earlier versions) of the radio access network, several base stations are typically connected (e.g., by landlines or microwave) to a radio network controller (RNC). The radio network controller, also sometimes termed a base station controller (BSC), supervises and coordinates various activities of the plural base stations connected thereto. The radio network controllers are typically connected to one or more core networks.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) access technology. Universal Terrestrial Radio Access Network (UTRAN) is essentially a radio access network using wideband code division multiple access for user equipments (UEs). The Third Generation Partnership Project (3GPP) has undertaken to evolve further the UTRAN and GSM based radio access network technologies.

Long Term Evolution (LTE) is a variant of a 3GPP radio access technology wherein the radio base station nodes are connected directly to a core network rather than to radio network controller (RNC) nodes. In general, in LTE the functions of a radio network controller (RNC) node are performed by the radio base station nodes. As such, the radio access network (RAN) of an LTE system has an essentially flat architecture comprising radio base station nodes without reporting to radio network controller (RNC) nodes.

The following description, for purposes of explanation, refers to LTE, WCDMA, UTRAN or evolved UTRAN (E-UTRAN or eUTRAN). This does however not limit the applicability to other technologies.

UTRAN and LTE offer so called access control mechanisms by which the network can prevent UEs from accessing the network. Obviously, this is desirable when the network experiences an unsustainable high load. This may be the case if, due to access burst, there are no further radio or processing resources in the eNB/NB available to fulfil the service requirements of all UEs that desire to transmit data. In such situations it is preferable to prevent additional (IDLE) UEs from accessing the network and thereby to offer sufficient quality of experience to already connected UEs. This is known as access barring. Similarly, the NW may decide to reject or release already connected (RRC CONNECTED) UEs from the NW. This is known as RRC CONNECTION REJECT or RRC CONNECTION RELEASE. Standardized access barring schemes allow to block certain UEs while still permitting others to access the network. In particular the specifications allow distinguishing mobile terminating calls, mobile originating calls, emergency calls, mobile originating signalling, mobile originating CS fall-back, special access classes (Access Classes 11-15), and extended access barring (for lower priority traffic). Furthermore, there exist means to prevent UEs from performing access for multimedia telephony (MMTEL) MMTEL-Voice or MMTEL-Video. In LTE and UMTS the access barring schemes are currently only applicable for UEs in IDLE mode. That means, a UE that is already in RRC CONNECTED may access the network even if the current cell indicates that access is barred. It has recently been proposed in 3GPP to extend access barring so that it is also applicable to UEs in RRC CONNECTED. Such investigations are on-going.

LTE and UMTS make use of so called quality of service (QoS) Classes (QCI) that were introduced to achieve an abstraction between services and their quality of service requirements on one side and the RAN and its scheduling QoS logic on other side.

The core network (CN) decides how many different levels of quality of service need to be distinguished in the RAN (and potentially in the transport and core network) and sets up a corresponding number of radio bearers for each UE. The core network also defines so-called packet filters which allow the non-access-stratum (NAS) layer in the UE and the core network (in a gateway of the CN) to decide which packet to map onto which bearer. This filtering is primarily done based on source and destination IP address and port number. It is therefore flexible so that the network can easily map different kinds of applications to different bearers.

With this approach, the access stratum (in the RAN) only distinguishes bearers while it does not need to be service aware. All data mapped (by packet filters in the UE) onto one bearer is expected to get the same QoS treatment by the RAN and the UE. The packet treatment is determined by the core network which sets the QoS class indicator (QCI) for each established bearer.

In the RAN, evolved packet system (EPS) bearers are mapped to data radio bearers (DRBs) having logical channel identity (LCI). Scheduling and prioritization of data packets in the RAN is done based on logical channels in radio resource control (RRC) Connected mode.

### SUMMARY

While the existing access barring mechanisms seems to offer already great level of flexibility, it turns out that not all use cases can be fulfilled with the standardized access barring schemes. It is e.g. not possible to bar radio devices/UEs that are performing normal data access while allowing UEs that try to establish a VoIP call. The above-mentioned barring of MMTEL-Voice allows only to provide lower priority for voice as compared to other traffic. Furthermore, if the UE passes this barring check, then it will still undergo the general barring of mobile originating calls like UEs performing regular (Internet) data transmission.

A possible way to improve the access barring scheme would be to define additional groups of services and to define corresponding access barring thresholds for those. E.g. one could define a group for Internet access which could be barred while access for MMTEL-Voice would still be permitted. However, it becomes apparent that such a concept becomes complex and still not very flexible when one expects that there might be other services in the future that require individual barring.

Generally, there is an attempt to keep the RAN protocols service agnostic in order to avoid RAN internal mechanisms needing to be changed in specifications every time new services or new service requirements appear on the market. Many of the currently existing access barring scheme refer explicitly to particular services and are therefore inflexible and complex.

Another challenge related to current access barring mechanisms is that these mechanisms are not applicable in RRC Connected mode. The only exception is accessing to another domain (PS/CS) in UTRAN. It can be expected that more and more UEs remain in RRC connected mode. Thus, there is a need to develop solutions to control access attempts of connected mode UEs after an inactivity period. However, current barring procedures in the UE are executed during the RRC Connection establishment procedure in the RRC layer based on call type information provided by the so called non-access stratum layer (NAS layer). When the UE is already in the connected mode, there are neither corresponding RRC procedures nor the call types provided by NAS layer based on which barring could be applied. Thus legacy access class methods cannot be easily applied to the connected mode UEs.

Today, many mobile broadband networks are highly loaded in particular during peak hours. In such situations it is often not possible to admit all UEs to the network while still maintaining the expected level of QoS to all of them. It is then desirable to block certain traffic in order to maintain at least the important traffic (e.g. VoIP or higher priority data or traffic from premium subscribers). The existing barring mechanisms do not offer this level of flexibility. Extending the existing mechanisms in the straight-forward way would further increase the complexity, still not be very flexible and make the RAN service aware. On the other hand the solution presented in the present disclosure allows blocking or allowing traffic of e.g. selected quality of service classes while keeping the RAN service agnostic. This is achieved by re-using the existing QoS framework and by associating barring parameters with a characteristic of a bearer defined between a radio device/UE and the CN, e.g. QCIs/bearer identities.

According to an aspect of the present disclosure, there is provided a method performed in a radio device. The method comprises receiving, over a radio interface, a message comprising at least one barring parameter associated with a characteristic of a logical bearer between the radio device and a core network (CN). The method also comprises determining that an uplink (UL) data packet is associated with the characteristic of the logical bearer. The method also comprises determining, based at least on the barring parameter, whether access for transmitting the UL data packet over the radio interface is allowed.

According to another aspect of the present disclosure, there is provided a radio device comprising processor circuitry, and a storage unit storing instructions executable by said processor circuitry whereby said radio device is operative to receive, over a radio interface, a message comprising at least one barring parameter associated with a characteristic of a logical bearer between the radio device and a CN. The radio device is then also operative to determine that an UL data packet is associated with the characteristic of the logical bearer. The radio device is then also operative to determine, based at least on the barring parameter, whether access for transmitting the UL data packet over the radio interface is allowed.

According to another aspect of the present disclosure, there is provided a computer program comprising instructions, the instructions being adapted to, if executed on processor circuitry of a radio device, cause the radio device to perform an embodiment of a method of the present disclosure.

According to another aspect of the present disclosure, there is provided a method performed in a radio access network (RAN) node. The method comprises determining at least one barring parameter which, in a radio device, should be associated with a characteristic of a logical bearer between the radio device and a core network (CN). The method also comprises transmitting, over a radio interface, a message to the radio device, the message comprising the at least one barring parameter.

According to another aspect of the present disclosure, there is provided a RAN node comprising processor circuitry, and a storage unit storing instructions executable by said processor circuitry whereby said RAN node is operative to determine at least one barring parameter which, in a radio device, should be associated with a characteristic of a logical bearer between the radio device and a CN. The RAN node is then also operable to transmit, over a radio interface, a message to the radio device, the message comprising the at least one barring parameter.

According to another aspect of the present disclosure, there is provided a computer program comprising instructions, the instructions being adapted to, if executed on processor circuitry of a RAN node, cause the RAN node to perform an embodiment of a method of the present disclosure.

According to another aspect of the present disclosure, there is provided a method performed in a CN node in a CN. The method comprises determining an order of priority between different logical bearers between a radio device and the CN, said bearers having different characteristics. The method also comprises transmitting a message comprising said order of priority to a RAN node.

According to another aspect of the present disclosure, there is provided a CN node for a CN. The CN node comprises processor circuitry, and a storage unit storing instructions executable by said processor circuitry whereby said CN node is operative to determine an order of priority between different logical bearers between a radio device and the CN, said bearers having different characteristics. The CN node is then also operative to transmit a message comprising said order of priority to a RAN node.

According to another aspect of the present disclosure, there is provided a computer program comprising instructions, the instructions being adapted to, if executed on processor circuitry of a CN node in a core network, cause the CN node to perform an embodiment of a method of the present disclosure.

According to another aspect of the present disclosure, there is provided a computer program product comprising an embodiment of a computer program of the present disclosure and a computer readable means on which the computer program is stored.

It is an advantage of the embodiments of the present disclosure to introduce a new access barring scheme that allows to explicitly bar or admit traffic corresponding to e.g. particular QCIs and/or EPS bearer types/identities. That means, rather than defining groups of traffic, services or UE types in the RAN level specifications, the QCIs (or other characteristic) and corresponding packet filters are used as abstraction layer. This gives significant additional flexibility while keeping specification and implementation relatively simple.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 is a schematic diagram illustrating filtering of data packets according to prior art.

FIG. 2 is a schematic diagram of a radio communication system in which embodiments of the present disclosure can be employed.

FIG. 3 is a schematic diagram illustrating filtering of data packets in accordance with embodiments of the present disclosure.

FIG. 4 is a schematic block diagram of an embodiment of a radio device/UE of the present disclosure.

FIG. 5 is a schematic block diagram of an embodiment of a radio RAN node of the present disclosure.

FIG. 6 is a schematic block diagram of an embodiment of a radio CN node of the present disclosure.

FIG. 7a is a schematic flow chart of an embodiment of a method of the present disclosure.

FIG. 7b is a schematic flow chart of another embodiment of a method of the present disclosure.

FIG. 8a is a schematic flow chart of another embodiment of a method of the present disclosure.

FIG. 8b is a schematic flow chart of another embodiment of a method of the present disclosure.

FIG. 9 is a schematic flow chart of another embodiment of a method of the present disclosure.

FIG. 10 is a schematic illustration of an embodiment of a computer program product of the present disclosure.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

The radio device may be any device, mobile or stationary, enabled to communicate over a radio cannel in a communications network, for instance but not limited to e.g. mobile phone, smart phone, modem, sensors, meters, vehicles (e.g. a car), household appliances, medical appliances, media players, cameras, or any type of consumer electronic, for instance but not limited to television, radio, lighting arrangements, tablet computer, laptop, or personal computer (PC). Herein the radio device is also referred to as e.g. a user equipment (UE) or a mobile terminal.

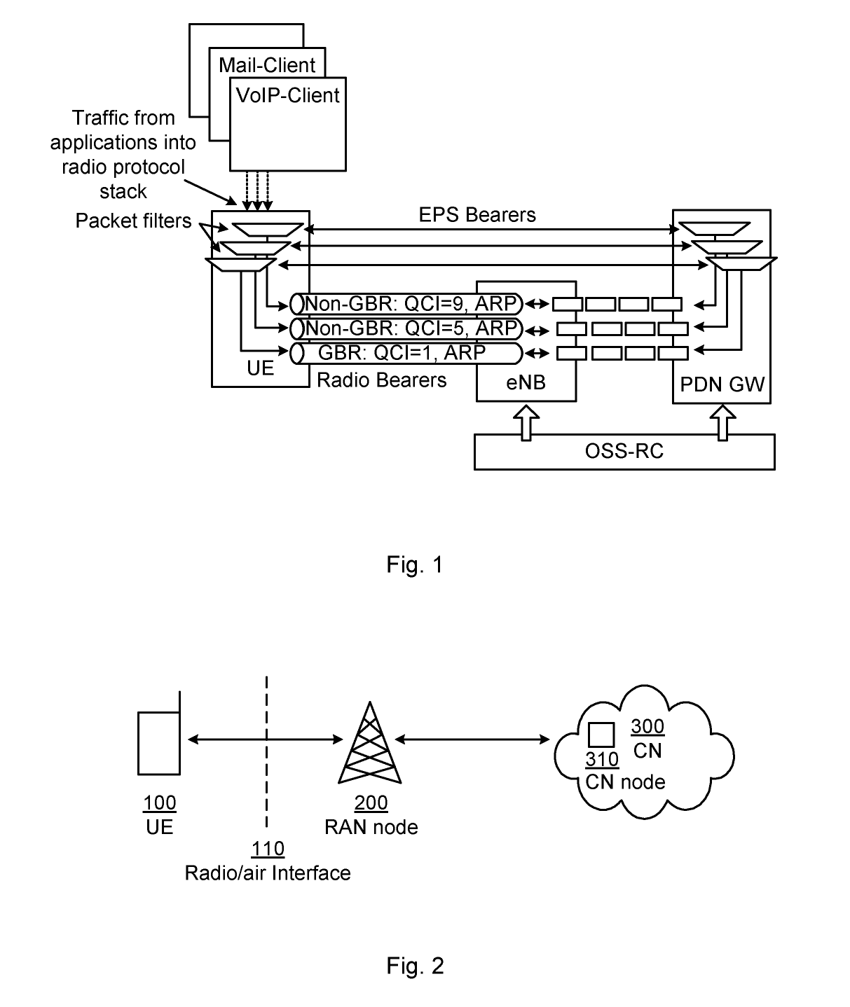

FIG. 1 illustrates a legacy system. EPS bearers are an example of logical bearers set up between a UE and a packet data network (PDN) gateway (GW) which is a node of the CN. An eNB is part of a RAN between the UE and the CN and act to set up the physical communication there between. An operations support system-radio and core (OSS-RC) functionality act on both the PDN GW and the eNB. For communication over the air interface between the UE and the eNB, radio bearers are set up. A plurality of clients or applications generate data packets for the radio protocol stack in the UE. These data packets are mapped to different EPS bearers by means of packet filters in the UE. The EPS bearers are then mapped to radio bearers. The EPS bearers, and consequently the data packets and the radio bearers, have or are associated with different characteristics, such as guarantied bit rate (GBR) or non-GBR, different QCI values e.g. 1.15, and/or allocation and retention priority values (ARP). Bearers corresponding to the radio bearers between the eNB and the UE are set up between the eNB and the CN via the PDN GW. Even if the radio bearers are terminated, the EPS bearers may remain and patterned with future set up of radio bearers.

FIG. 2 is a schematic diagram of a radio communication system in which embodiments of the present disclosure can be employed. A radio device 100, here called a UE, is connected to a RAN node 200, e.g. a NB, eNB or other base station, over a radio or air interface 110. The RAN node 200 is in its turn connected to a CN 300 comprising a CN node 310.

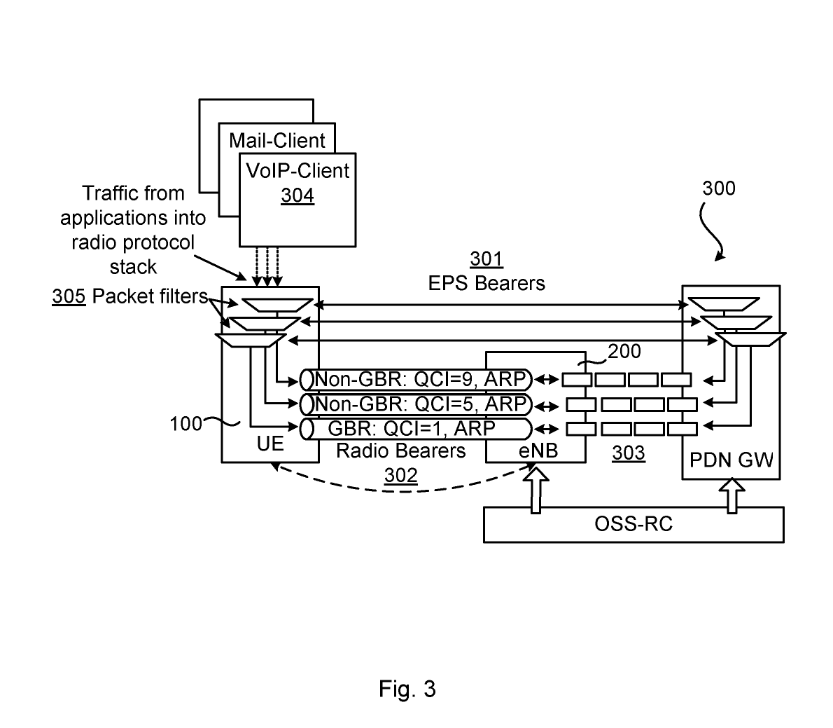

FIG. 3 is a schematic diagram illustrating filtering of data packets in accordance with embodiments of the present disclosure. EPS bearers 301 are an example of logical bearers set up between a radio device 100 (here called a UE) and a CN 300 e.g. via a packet data network (PDN) gateway (GW) which is a node of the CN. A RAN node 200 (here in the form of an eNB) is part of a RAN between the UE 100 and the CN 300 and act to set up the physical communication there between. An operations support system-radio and core (OSS-RC) functionality may act on both the PDN GW and the eNB 200. For communication over the air interface 110 between the UE and the eNB, radio bearers 302 are set up. A plurality of clients or applications 304 generate data packets for the radio protocol stack in the UE 100. These data packets are associated with different EPS bearers by means of packet filters 305 in the UE and then mapped to different radio bearers 302. The EPS bearers 301, and consequently the data packets and the radio bearers 302, have or are associated with different characteristics, such as guarantied bit rate (GBR) or non-GBR, different QCI values e.g. 1.15, and/or allocation and retention priority values (ARP). Bearers 303 corresponding to the radio bearers 302 between the eNB and the UE are set up between the eNB and the CN via the PDN GW. Even if the radio bearers are terminated, the EPS bearers may remain and patterned with future set up radio bearers. At 1), a dashed arrow illustrates the transmitting of barring parameters for each QCI (an example of a bearer characteristic) from the eNB to the UE. At 2), the UE applies the received barring parameters to filter the data packets depending on with which QCI each data packet is associated by means of the filters 305.

As described above, LTE and UMTS make use of so called QCIs and corresponding bearers to enable quality of service while keeping the RAN service agnostic.

When the radio device 100 attaches to the network initially, the network configures it with at least a default bearer which usually carries normal Internet traffic (e.g. QCI9). Typically, it also configures a bearer that carries IMS signalling traffic towards IP Multimedia Subsystem or IP Multimedia Core Network Subsystem (IMS) domain (e.g. QCI5).

The network also configures packet filters in the core network 300 and in the radio device 100 which ensure that IP packets to and from the IMS domain are carried on the QCI5 bearer whereas IP packets that match no other filter end up on the QCI9 bearer.

During the initial attach procedure, the radio device 100 moves to RRC connected state. Meanwhile, the Data Radio Bearers 302 corresponding to EPS bearers 301 are established. When the radio device 100 is later released to IDLE mode, the Radio Bearers 302 are released. However, the EPS bearers 301 (between core network 300 and radio device 100 NAS level) as well as the corresponding packet filters 305 are maintained. That means, upon arrival of new uplink data the radio device 100 can still determine to which QCI the IP packet belongs before handing it from a higher layer (i.e. a layer in the UE protocol which is above the radio protocols) to the access stratum (AS) level.

As explained herein, a cell could e.g. indicate in broadcast signalling that a radio device 100 is explicitly allowed or prohibited to access the network when it has data that matches a certain packet filter, i.e., traffic belonging on a certain QCI/bearer. In the following, QCI values of the bearer are used to distinguish different bearer types, but embodiments of the present disclosure are also applicable to other EPS bearer level identifier/field such as EPS bearer identity.

### Example 1

In a first example, the legacy barring parameters in system information may indicate that “mobile originating calls” are barred. However, the NW may indicate that access is explicitly allowed (override legacy access barring) when triggered by data belonging to e.g. QCI5 or QCI1. UEs 100 that are RRC CONNECTED or IDLE and have a QCI5 or QCI1 bearer established, may therefore still access the network to transfer corresponding data (e.g. IMS signalling and voice over internet protocol (VoIP) data). They must however not access the network for traffic not matching any of these QoS classes (filters 305 are used). This can be explicitly indicated with per-QCI barring parameters or be result of other barring methods. Furthermore, UEs 100 that just perform an initial ATTACH or for other reasons do not yet have an established QCI5 (or QCI1) bearer are not allowed to access unless they want to trigger e.g. an emergency call or some other data that is not barred (e.g. UEs that perform initial attach, may access if the call type “originated signalling” is not barred).

### Example 2

In a second example, per-QCI barring could be applied even though legacy barring is not configured. This is considered useful e.g. if UEs 100 that do not yet have bearers established should be allowed to access the network. Also it can be that the network may not implement the legacy access class barring mechanism at all but rely solely on per-QCI mechanisms. To realize this, the network would not set the legacy barring parameters (e.g. mobile originating calls, etc.) and thereby, by default, allow all UEs 100 to access the network. During initial attach or when the UE does not have (EPS-) bearers 301 configured for other reasons, the UE 100 may access the network. Once entering RRC CONNECTED state, the UE will be configured with at least one default bearer (e.g. QCI9) and possibly with e.g. a QCI5 bearer that is supposed to carry time critical IMS signalling. If the network experiences high load, it may indicate to UEs that access triggered by data on a QCI9 bearer is barred. Subsequently, the UE will not be allowed to access again for the purpose of transferring data that matches the filter of the QCI9 bearer.

### Example 3

In one embodiment, the per-QCI/bearer barring may be applicable to UEs 100 that are IDLE or RRC CONNECTED. That means, it could prohibit or explicitly allow random access (in IDLE or CONNECTED) or dedicated scheduling request (in CONNECTED). In other embodiments, the barring rules could be applicable only to UEs in CONNECTED or only to UEs in IDLE mode. To further increase the flexibility of the embodiment of the present disclosure, the barring parameters provided to the UEs 100 could explicitly indicate to which state they apply (IDLE and/or CONNECTED). In systems like UMTS where more than two states exist, it may be beneficial to further distinguish the sub-states (CELL_FACH, URA_PCH, etc.) in which barring should be applicable.

### Example 4

In the examples and embodiments above, barring parameters are provided per QCI or per bearer 301. In order to save signalling overhead, it may also or alternatively be allowed to signal a set of barring parameters for a group of QCI values or bearers 301. That means e.g. that the network may indicate that access triggered by data on bearers with QCI9, 8 or 7 is barred. Or it may e.g. indicate that access triggered by data on bearers with QCI1, 4 or 5 is explicitly allowed and thus not barred.

### Example 5

In an embodiment of the present disclosure, the RAN node 200 controls the access load it has dynamically based on load situation. When the access load e.g. in terms of random access attempts or number of connected UEs 100 exceeds a certain threshold, the RAN node 200 starts to broadcast barring parameters starting from the bearer 301 having a lowest priority. The priority order can be given by the core network node in a static or temporal manner. In one solution, existing Allocation and Retention Priority values (ARPs) of each bearer are reused in such away that barring is started from the lowest priority bearers based on ARP.

In the examples and embodiments above, the barring may be bypassed if the UE 100 establishes a connection for an emergency call or has a valid special access class (AC 10-15).

Barring rules and corresponding transmitted/received barring parameters could be realized for example as on/off indication (bar/allow), by means of access classes, as a probability function (random number) or as a random time offset (delay timer). In addition, the network may transmit an indication that all legacy barring mechanisms should be bypassed e.g. by all UEs 100. Such an indication may be a new bit in the transmitted message or implicitly derived from the presence of QCI-based barring parameters.

In UMTS and LTE, the packet filters 305 and EPS bearers 301 are configured e.g. on the NAS layer (the actual packet filter may be in another layer). This layer defines protocols and functionality between the CN 300 and the UE 100. On the other hand, protocols and functionality between UE and radio access network (RAN; eNB, RNC/NB) 200 is denoted access stratum (AS). Access barring parameters are today broadcast by the RAN (eNB/NB) 200 and therefore processed by the UEs' AS layer. In a preferred embodiment of this concept the barring parameters of the present disclosure are provided to a higher layer (NAS) where they may be stored. Then the parameters may be applied as part of the packet filtering 305. Barring parameters may be provided by the AS layer of the UE 100 to the NAS layer both in connected and IDLE mode.

Furthermore, in the embodiments where QCI-based barring overrides existing barring mechanisms, the higher layer may first perform a QCI-based barring check. If access is explicitly allowed, the NAS layer or other higher layer may notify the RRC layer e.g. with a new call type or other indication that the legacy barring can be bypassed in the RRC layer. In the case where legacy barring is bypassed by all QCIs 100 (as indicated by the network with broadcasted information), already the AS layer may perform such bypassing without further interaction between AS and higher layer.

Some examples of existing (legacy) barring parameters are given below.

If the network discovers that there is congestion, e.g. in a random access channel, the network may start to restrict certain UEs from performing a random access procedure so that the UE is effectively barred from accessing the network. The network may broadcast access barring information to indicate which UEs are barred from accessing the network. When the network congestion is alleviated, the network may remove the access restrictions to allow the UEs to access the network again

In Access Class Barring (ACB) for UTRAN, Access classes are used to identify which portion of the mobile terminals are allowed or disallowed to access the network at certain time. For example, access attempts by UEs belonging to class 0, 1, and 2 may be limited whereas UEs belong to classes 3-9 are allowed to access the network. In another example, access attempts by UEs belonging to a normal access class may be limited whereas access attempts by UEs belonging to a special access class may be allowed. In UTRAN standards, to inform the mobile terminals of the allowed/disallowed access classes, a bitmap indicating which access classes are barred and which are not may be broadcast by the network.

In E-UTRAN standards, the ACB mechanism is implemented using an access barring factor and an access barring time, both of which are broadcast in the system information (SI) when access class barring is in effect. These parameters are same for all Access Classes 0-9.

In the embodiments of the present disclosure where QCI-based barring is mainly used without legacy barring mechanisms, the higher layer may itself check if access is allowed or not without any further interaction with AS.

In the present description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

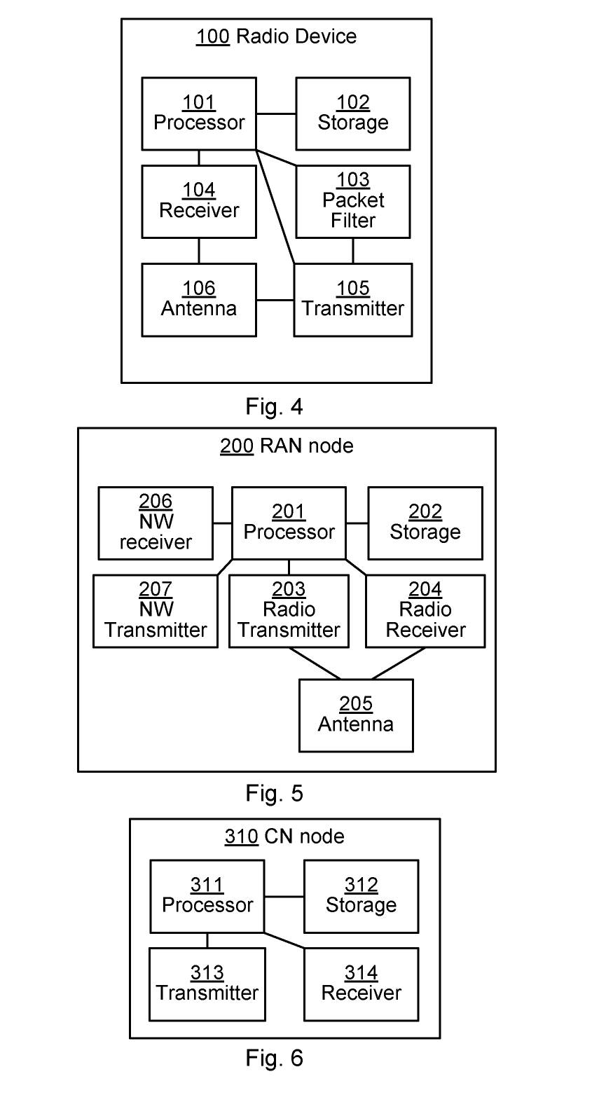

FIG. 4 schematically illustrates an embodiment of a radio device/UE 100 of the present disclosure. The radio device 100 comprises a processor or central processing unit (CPU) 101. The processor 101 may comprise one or a plurality of processing units in the form of microprocessor(s). However, other suitable devices with computing capabilities could be used, e.g. an application specific integrated circuit (ASIC), a field programmable gate array (FPGA) or a complex programmable logic device (CPLD). The processor 101 is configured to run one or several computer program(s) or software stored in a storage unit or memory 102. The storage unit is regarded as a computer readable means and may e.g. be in the form of a Random Access Memory (RAM), a Flash memory or other solid state memory, or a hard disk. The processor 101 is also configured to store data in the storage unit 102, as needed. The radio device 100 also comprises a transmitter 105, a receiver 104 and an antenna 106, which may be combined to form a transceiver or be present as distinct units within the radio device 100. The transmitter 105 is configured to cooperate with the processor to transform data bits to be transmitted over a radio interface no to a suitable radio signal in accordance with the radio access technology (RAT) used by the RAN via which the data bits are to be transmitted. The receiver 104 is configured to cooperate with the processor 101 to transform a received radio signal to transmitted data bits. The antenna 106 may comprise a single antenna or a plurality of antennas, e.g. for different frequencies and/or for MIMO (Multiple Input Multiple Output) communication. The antenna 106 is used by the transmitter 105 and the receiver 104 for transmitting and receiving, respectively, radio signals. The radio device 100 additionally comprises one or several packet filters 103 which are responsible for mapping UL data packets to the appropriate radio bearer 302, before the packets are transferred to the transmitter 105. The packet filters 103 is also employed to apply the barring parameter(s) received by the radio device 100 in accordance with the present disclosure.

FIG. 5 is a schematic block diagram of an embodiment of a radio RAN node 200 of the present disclosure. The RAN node 200 comprises a processor 201 e.g. a central processing unit (CPU). The processor 201 may comprise one or a plurality of processing units in the form of microprocessor(s). However, other suitable devices with computing capabilities could be comprised in the processor 201, e.g. an application specific integrated circuit (ASIC), a field programmable gate array (FPGA) or a complex programmable logic device (CPLD). The processor 201 is configured to run one or several computer program(s) or software stored in a storage unit 202 e.g. a memory. The storage unit is regarded as a computer readable means and may e.g. be in the form of a Random Access Memory (RAM), a Flash memory or other solid state memory, or a hard disk. The processor 201 is also configured to store data in the storage unit 202, as needed. The RAN node 200 also comprises a radio transmitter 203, a radio receiver 204 and an antenna 205, which may be combined to form a transceiver or be present as distinct units within the RAN node 200. The radio transmitter 203 is configured to cooperate with the processor to transform data bits to be transmitted over the radio interface 110 to a suitable radio signal in accordance with the radio access technology (RAT) used by the Radio Access Network (RAN) via which the data bits are to be transmitted. The radio receiver 204 is configured to cooperate with the processor 201 to transform a received radio signal to transmitted data bits. The antenna 205 may comprise a single antenna or a plurality of antennas, e.g. for different frequencies and/or for MIMO (Multiple Input Multiple Output) communication. The antenna 205 is used by the radio transmitter 203 and the radio receiver 204 for transmitting and receiving, respectively, radio signals. The radio transmitter and the radio receiver can be viewed as part of a radio interface of the RAN node 200. Similarly, the RAN node 200 comprises a network (NW) interface comprising an NW receiver 206 and an NW transmitter 207 for communication with e.g. a CN node 310.

FIG. 6 is a schematic block diagram of an embodiment of a radio CN node 310 of the present disclosure. The CN node 310 comprises a processor 311 e.g. a central processing unit (CPU). The processor 311 may comprise one or a plurality of processing units in the form of microprocessor(s). However, other suitable devices with computing capabilities could be comprised in the processor 311, e.g. an application specific integrated circuit (ASIC), a field programmable gate array (FPGA) or a complex programmable logic device (CPLD). The processor 311 is configured to run one or several computer program(s) or software stored in a storage unit 312 e.g. a memory. The storage unit is regarded as a computer readable means and may e.g. be in the form of a Random Access Memory (RAM), a Flash memory or other solid state memory, or a hard disk. The processor 311 is also configured to store data in the storage unit 312, as needed. The CN node 310 also comprises a transmitter 313 and a receiver 314, which may be combined to form a transceiver or be present as distinct units within the CN node 310. The transmitter 313 is configured to cooperate with the processor to transform data bits to be transmitted to a suitable signal. The receiver 314 is configured to cooperate with the processor 311 to transform a received signal to transmitted data bits. The transmitter and the receiver can be viewed as part of a NW interface for communication with e.g. a RAN node 200 or another CN node 310.

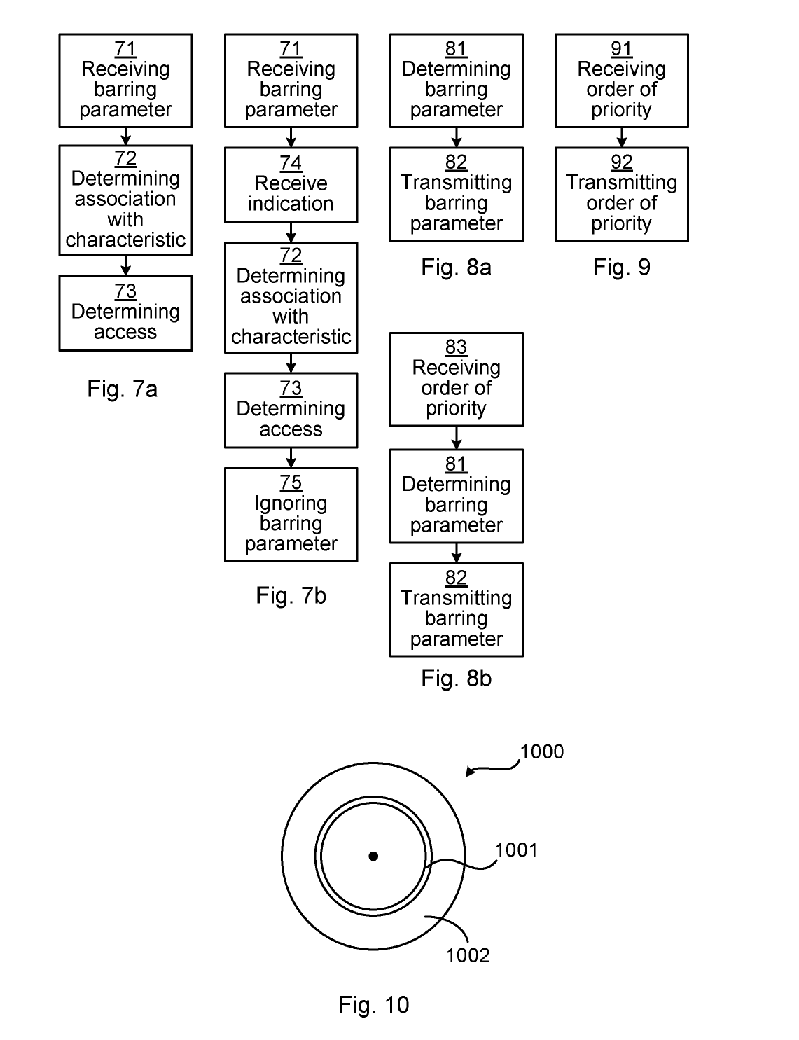

FIG. 7a is a schematic flow chart of an embodiment of a method performed in a radio device 100, of the present disclosure. A message comprising at least one barring parameter associated with a characteristic of a logical bearer 301 between the radio device 100 and a CN 300 is received 71 by the radio device over a radio interface e.g. the antenna 106. Before, during or after the receiving 71, the radio device 100 determines 72 that an UL data packet is associated with the characteristic of the logical bearer 301. Then, the radio device determines 73 whether access for transmitting the UL data packet over the radio interface 106 is allowed, based at least on the barring parameter.

FIG. 7b is a schematic flow chart of another embodiment of a method performed in a radio device 100, of the present disclosure. The receiving 71 of the barring parameter, the determining 72 of association with the characteristic, and the determining 73 whether access is allowed are as discussed with reference to FIG. 7a. Additionally, the radio device 100 may, prior to the determining 73 whether access is allowed, receive 74 an indication indicating to the radio device 100 whether, and optionally to what extent, to ignore an access control mechanism, e.g. any other access barring mechanism than the access barring mechanism described in the present disclosure. Additionally or alternatively, the radio device 100 may ignore 75 the received 71 barring parameter when a condition is met, e.g. a need to set up an emergency call or when the UL data packet has a special access class.

FIG. 8a is a schematic flow chart of an embodiment of a method performed in a RAN node 200, of the present disclosure. The RAN node determines 81 at least one barring parameter which, in a radio device 100, should be associated with a characteristic of a logical bearer 301 between the radio device 100) and a core network 300. Then, the RAN node 200 transmits 82 a message to the radio device 100, over a radio interface (e.g. via the antenna 205), the message comprising the at least one barring parameter which has been determined 81.

FIG. 8b is a schematic flow chart of another embodiment of a method performed in a RAN node 200, of the present disclosure. The determining 81 of the barring parameter as well as the transmitting 82 of said barring parameter are as in FIG. 8a. Additionally, the RAN node 200 may receive 83, from the CN 300, a message comprising an order of priority between different logical bearers 301 between the radio device 100 and the CN 300, prior to the determining 81 of the at least one barring parameter.

FIG. 9 is a schematic flow chart of an embodiment of a method performed in a CN node 310 in the core network 300, of the present disclosure. The CN node 310 determines 91 an order of priority between different logical bearers 301 between a radio device 100 and the CN 300, said bearers having different characteristics. Then, the CN node 310 transmits 92 a message comprising said order of priority to a RAN node 200. The RAN node 200 may then use the order of priority in accordance with FIG. 8b.

FIG. 10 illustrates a computer program product 1000. The computer program product 1000 comprises a computer readable medium 1002 comprising a computer program 1001 in the form of computer-executable components 1001. The computer program/computer-executable components 1001 may be configured to cause a device, e.g. a radio device 100, RAN node 200 or CN node 310 as discussed herein, to perform an embodiment of the method of the present disclosure. The computer program/computer-executable components may be run on the processor circuitry 101/201/311 of the device for causing the device to perform the method. The computer program product 1000 may e.g. be comprised in a storage unit or memory 102/202/312 comprised in the device and associated with the processor circuitry. Alternatively, the computer program product 1000 may be, or be part of, a separate, e.g. mobile, storage means, such as a computer readable disc, e.g. CD or DVD or hard disc/drive, or a solid state storage medium, e.g. a RAM or Flash memory.

In some embodiments of the present disclosure, the characteristic of the logical bearer 301 is a quality of service class identifier (QCI) value or a bearer identity e.g. an EPS bearer identity.

In some embodiments of the present disclosure, the determining 72 of the radio device 100 that an UL data packet is associated with the characteristic of the logical bearer 301 is performed by means of a packet filter 103 previously configured into the radio device 100.

In some embodiments of the present disclosure, the barring parameter comprises a binary indication (bar/allowed, e.g. 1 for allowed and 0 for not allowed/barred) of whether or not UL traffic associated with the characteristic of the logical bearer 301 is allowed or not.

In some embodiments of the present disclosure, the barring parameter comprises a barring probability and wherein said determining 73 by the radio device 100, based at least on the barring parameter whether access for transmitting the UL data packet over the radio interface 106 is allowed, comprises obtaining a random number and comparing said random number to the barring probability broadcasted by the radio network. If the random number derived by the UE is greater/smaller than the barring probability, then the access is allowed. If the access is barred, then the UE may need to wait for the expiry of a random timer which is determined based on the configured barring delay and the derived random number.

In some embodiments of the present disclosure, the determining 73 by the radio device whether access is allowed comprises starting a timer when it has been determined that access for transmitting the UL data packet over the radio interface is not allowed, whereby UL data packets associated with the characteristic of the logical bearer 301 are determined to be not allowed while the timer is running.

In some embodiments of the present disclosure, the determining 73 by the radio device whether access is allowed is based on access classes where the binary information for QCI is combined with the access class information. Network may broadcast that QCI5 is allowed as well as Access Classes for which the allowance is valid. The radio device determines based on the QCI and the valid Access Class whether access for transmitting the UL data packet over the radio interface 106 is allowed.

In some embodiments of the present disclosure, the determining 73 by the radio device 100 whether access is allowed is based on the barring parameter while any other access barring mechanism is ignored.

In some embodiments of the present disclosure, the message received 71 by the radio device 100 as well as transmitted 82 by the RAN node 200 prompts the radio device 100 to combine the received barring parameter with another, typically already active/implemented, access control mechanism, e.g. any other access barring mechanism.

In some embodiments of the present disclosure, the radio device 100 is in RRC CONNECTED mode, while in other embodiments it is in RRC IDLE mode.

In some embodiments of the present disclosure, the message received 71 by the radio device 100 as well as transmitted 82 by the RAN node 200 comprises a plurality of barring parameters associated with the characteristic of the logical bearer 301. For instance, the barring parameters may include a parameter allowing access for a data packet associated with the characteristic if a condition is met and a parameter not allowing (blocking/barring) access for a data packet associated with the characteristic if another condition is met.

In some embodiments of the present disclosure, the at least one barring parameter is associated with a plurality of logical bearers 301 between the radio device 100 and the CN 300. Thus, barring parameter(s) may be defined for some or all logical bearers 301.

Below follow some other aspects and embodiments of the present disclosure.

According to an aspect of the present disclosure, there is provided a radio device 100 comprising means (e.g. the processor circuitry 101 in cooperation with the receiver 104) for receiving 71, over a radio interface (e.g. including the antenna 106), a message comprising at least one barring parameter associated with a characteristic of a logical bearer 301 between the radio device 100 and a CN 300. The radio device also comprises means (e.g. the processor circuitry 101) for determining 72 that an UL data packet is associated with the characteristic of the logical bearer 301. The radio device also comprises means (e.g. the processor circuitry 101 and/or the filter circuitry 103) for determining 73, based at least on the barring parameter, whether access for transmitting the UL data packet over the radio interface 106 is allowed.

According to another aspect of the present disclosure, there is provided a RAN node 200 comprising means (e.g. the processor circuitry 201) for determining 81 at least one barring parameter which, in a radio device 100, should be associated with a characteristic of a logical bearer 301 between the radio device 100 and a CN 300. The RAN node also comprises means (e.g. the processor circuitry 201 in cooperation with the radio transmitter 203) for transmitting 82, over a radio interface (e.g. comprising the antenna 205), a message to the radio device 100, the message comprising the at least one barring parameter.

According to another aspect of the present disclosure, there is provided a CN node 310 for a CN 300, the CN node comprising means (e.g. the processor circuitry 311) for determining 91 an order of priority between different logical bearers 301 between a radio device 100 and the CN 300, said bearers having different characteristics. The CN node also comprises means (e.g. the processor circuitry 311 in cooperation with the transmitter 313) for transmitting 92 a message comprising said order of priority to a RAN node 200.

According to another aspect of the present disclosure, there is provided a method in a radio device 100. The method comprises receiving, over a radio interface 106, a message comprising at least one barring parameter associated with a characteristic of a logical bearer 301 between the radio device 100 and a core network (CN) 300. The method further comprises determining whether an uplink (UL) data packet is associated with the characteristic of the logical bearer 301. The method also comprises applying the barring parameter to the UL data packet to determine whether access for transmitting of the packet is allowed, if it has been determined that said data packet is associated with said characteristic.

In some embodiments of the above method, the receiving of the message comprising at least one barring parameter prompts the radio device 100 to ignore other access control mechanisms, such as access class barring mechanisms, specified for UTRAN and LTE.

In some embodiments of the above method, the receiving of the message comprising at least one barring parameter prompts the radio device 100 to combine the received barring parameters with other access control mechanisms, such as access class barring mechanisms, specified for UTRAN and LTE. The received barring parameter may e.g. override the other access control mechanisms for a data packet of the bearer associated with the characteristic, without affecting the other access control mechanisms for packets of other bearers.

According to another aspect of the present disclosure, there is provided a radio device 100. The radio device comprises receiver circuitry 104 configured for receiving, over a radio interface 106, a message comprising at least one barring parameter associated with a characteristic of a logical bearer301 between the radio device and a core network (CN) 300. The radio device 100 further comprises processor circuitry 101 configured for determining whether an uplink (UL) data packet is associated with the characteristic of the logical bearer. The radio device also comprises filter circuitry 103 configured for applying the barring parameter to the UL data packet to determine whether access for transmitting the packet is allowed, if it has been determined that said data packet is associated with said characteristic. The radio device aspect of the present disclosure may be configured for performing any embodiment of the method in a radio device discussed herein.

According to another aspect of the present disclosure, there is provided a method in a radio access network (RAN) node 200. The method comprises determining at least one barring parameter which, in a radio device 100, should be associated with a characteristic of a logical bearer 301 between the radio device 100 and a core network (CN) 300. The method also comprises transmitting, over a radio interface 205, a message to the radio device 100, the message comprising the at least one barring parameter associated with the characteristic of the logical bearer 301.

In some embodiments of the method in the RAN node 200, a separate indication is sent in a message, e.g. in the same message comprising the at least one barring parameter, from the RAN node to the radio device 100, indicating to the radio device whether, and optionally to what extent, to ignore other access control mechanisms, such as access class barring mechanisms, specified for UTRAN and LTE. Consequently, the method in the radio device may comprise receiving such a separate indication.

According to another aspect of the present disclosure, there is provided a radio access network (RAN) node 200. The RAN node comprises processor circuitry 201 configured for determining at least one barring parameter which, in a radio device 100, should be associated with a characteristic of a logical bearer 301 between the radio device and a core network (CN) 300. The RAN node also comprises transmitter circuitry 203 configured for transmitting, over a radio interface 205, a message to the radio device 100, the message comprising the at least one barring parameter associated with the characteristic of the logical bearer 301. The RAN node aspect of the present disclosure may be configured for performing any embodiment of the method in a RAN node discussed herein.

According to another aspect of the present disclosure, there is provided a method in a core network (CN) node 310. The method comprises determining an order of priority between different logical bearers 301 between a radio device 100 and the CN 300, said bearers having different characteristics. The method also comprises transmitting a message comprising said order of priority to a radio access network (RAN) node 200.

According to another aspect of the present disclosure, there is provided a core network (CN) node 310. The CN node comprises processor circuitry 311 configured for determining an order of priority between different logical bearers 301 between a radio device 100 and the CN 300, said bearers having different characteristics. The CN node 310 also comprises transmitter circuitry 313 configured for transmitting a message comprising said order of priority to a radio access network (RAN) node 200. This order of priority is related to the setting of barring parameters by the RAN node 200 or by the CN 300. In some embodiments, the CN node 310 is a Mobility Management Entity (MME) node. The CN node aspect of the present disclosure may be configured for performing any embodiment of the method in a CN node discussed herein.

According to another aspect of the present disclosure, there is provided a computer program 1001 comprising code for causing a radio device 100, a RAN node 200 or a CN node 310, as discussed herein, to perform an embodiment of a method of the present disclosure, when the code is run on processor circuitry 101, 201 or 311 comprised in the radio device, RAN node or CN node.

According to another aspect of the present disclosure, there is provided a computer program product 1000 comprising executable components 1001 for causing a radio device 100, a RAN node 200 or a CN node 310, as discussed herein, to perform an embodiment of a method of the present disclosure, when the components are run on processor circuitry 101, 201 or 311 comprised in the radio device, RAN node or CN node.

Below follow some more specific embodiments of the above given aspects of the present disclosure, each of which embodiments can be combined with any of the above aspects, as well as with any of the other embodiments discussed herein.

In some embodiments, the characteristic of the logical bearer 301 is a quality of service (QoS) class identifier (QCI) value or a bearer identity such as an EPS bearer identity.

In some embodiments, the radio device 100 comprises a packet filter 103 previously configured into the radio device by the CN 300, which packet filter performs the applying of the barring parameter to the UL data packet.

In some embodiments, the radio device 100 can ignore the received barring parameter if some condition is met, e.g. a need to set up an emergency call or if the data packet has a valid special access class (AC).

In some embodiments, the radio device 100 is in IDLE mode. In some other embodiments, the radio device 100 is in RRC CONNECTED mode. The network may broadcast information about whether the barring parameter(s) is applicable for IDLE and/or CONNECTED mode.

In some embodiments, the at least one barring parameter is associated with a group of logical bearers 301 between the radio device 100 and the CN 300, wherein the characteristic is the same or different for all the bearers in the group. The at least one barring parameter may e.g. be associated with any QCI value (as the bearer characteristic) between 1 to 5, or any other plurality of values.

In some embodiments, barring parameters for characteristics of all the logical bearers 301, e.g. EPS bearers, between the radio device 100 and the CN 300, are comprised in the message received by the radio device and sent by the RAN node 200, respectively.

In some embodiments, a plurality of barring parameters associated with the characteristic of the (single one) logical bearer 301 are comprised in the message received by the radio device 100 and sent by the RAN node 200, respectively. For instance, the barring parameters may include a parameter allowing access for a data packet associated with the characteristic if a condition is met and a parameter not allowing (blocking/barring) access for a data packet associated with the characteristic if another condition is met.

In some embodiments, the message received by the radio device 100 (as well as the message transmitted by the RAN node 200) comprising the at least one barring parameter, is a broadcasted message.

In some embodiments, the at least one barring parameter associated with the characteristic is an indication that access for a UL data packet associated with the characteristic should be: allowed, not allowed, or delayed e.g. depending on a timer or until a predetermined condition is met.

In some embodiments, the RAN node 200 receives a message comprising an order of priority between different logical bearers, from the CN 300, prior to determining the at least one barring parameter which, in a radio device 100, should be associated with the characteristic of a logical bearer 301.

In some embodiments, the logical bearer(s) 301 is an Evolved Packet System (EPS) bearer.

In some embodiments, the RAN node 200 is a Node B (NB) or an evolved Node B (eNB).

The present disclosure has mainly been described above with reference to a few embodiments. However, as is readily appreciated by a person skilled in the art, other embodiments than the ones disclosed above are equally possible within the scope of the present disclosure, as defined by the appended claims.

1-25. (canceled)

26. A method performed in a radio device, the method comprising:
receiving, over a radio interface, a message comprising at least one barring parameter associated with a characteristic of a logical bearer between the radio device and a core network (CN);
determining that an uplink (UL) data packet is associated with the characteristic of the logical bearer; and
determining, based at least on the barring parameter, whether access for transmitting the UL data packet over the radio interface is allowed.

27. The method of claim 26, wherein the characteristic of the logical bearer is a quality of service class identifier (QCI) value or a bearer identity.

28. The method of claim 26, wherein the determining that an UL data packet is associated with the characteristic of the logical bearer is performed by means of a packet filter previously configured into the radio device.

29. The method of claim 26, wherein the barring parameter comprises a binary indication of whether or not UL traffic associated with the characteristic of the logical bearer is allowed.

30. The method of claim 26, wherein the barring parameter comprises a barring probability and wherein said determining, based at least on the barring parameter whether access for transmitting the UL data packet over the radio interface is allowed, comprises obtaining a random number and comparing said random number to the barring probability.

31. The method of claim 26, wherein the determining whether access is allowed comprises starting a timer when it has been determined that access for transmitting the UL data packet over the radio interface is not allowed, whereby UL data packets associated with the characteristic of the logical bearer are determined to be not allowed while the timer is running.

32. The method of claim 26, wherein the determining whether access is allowed is based on the barring parameter while any other access barring mechanism is ignored.

33. The method of claim 26, wherein the receiving of the message prompts the radio device to combine the received barring parameter with another access control mechanism.

34. The method of claim 26, further comprising receiving an indication indicating to the radio device whether to ignore an access control mechanism.

35. The method of claim 26, further comprising ignoring the received barring parameter when a condition is met.

36. The method of claim 26, wherein the radio device is in RRC CONNECTED mode.

37. The method of claim 26, wherein the received message comprises a plurality of barring parameters associated with the characteristic of the logical bearer.

38. The method of claim 26, wherein the at least one barring parameter is associated with a plurality of logical bearers between the radio device and the CN.

39. A radio device comprising:
processor circuitry; and
a memory circuit storing instructions executable by said processor circuitry whereby said radio device is operative to:
receive, over a radio interface, a message comprising at least one barring parameter associated with a characteristic of a logical bearer between the radio device and a core network (CN);
determine that an UL data packet is associated with the characteristic of the logical bearer; and
determine, based at least on the barring parameter, whether access for transmitting the UL data packet over the radio interface is allowed.

40. A non-transitory computer-readable medium comprising, stored thereupon, computer program instructions configured for execution by processor circuitry on a radio device and configured so that, when executed by said processor circuitry, the computer program instructions cause the radio device to:
receive, over a radio interface, a message comprising at least one barring parameter associated with a characteristic of a logical bearer between the radio device and a core network (CN);
determine that an UL data packet is associated with the characteristic of the logical bearer; and
determine, based at least on the barring parameter, whether access for transmitting the UL data packet over the radio interface is allowed.

41. A method performed in a radio access network (RAN) node, the method comprising:
determining at least one barring parameter which, in a radio device, should be associated with a characteristic of a logical bearer between the radio device and a core network (CN); and
transmitting, over a radio interface, a message to the radio device, the message comprising the at least one barring parameter.

42. The method of claim 42, further comprising receiving, from the CN, a message comprising an order of priority between different logical bearers between the radio device and the CN, prior to the determining of the at least one barring parameter.

43. A RAN node comprising:
processor circuitry; and
a memory circuit storing instructions executable by said processor circuitry whereby said RAN node is operative to:
determine at least one barring parameter which, in a radio device, should be associated with a characteristic of a logical bearer between the radio device and a core network (CN); and
transmit, over a radio interface, a message to the radio device, the message comprising the at least one barring parameter.

44. A non-transitory computer-readable medium comprising, stored thereupon, computer program instructions configured for execution by processor circuitry on a RAN node and configured so that, when executed by said processor circuitry, the computer program instructions cause the RAN node to:
determine at least one barring parameter which, in a radio device, should be associated with a characteristic of a logical bearer between the radio device and a core network (CN); and
transmit, over a radio interface, a message to the radio device, the message comprising the at least one barring parameter.

45. A method performed in a CN node in a core network (CN) the method comprising:
determining an order of priority between different logical bearers between a radio device and the CN, said bearers having different characteristics; and
transmitting a message comprising said order of priority to a RAN node.

46. A CN node for a core network (CN) the CN node comprising:
processor circuitry; and
a memory circuit storing instructions executable by said processor circuitry whereby said CN node is operative to:
determine an order of priority between different logical bearers between a radio device and the CN, said bearers having different characteristics; and
transmit a message comprising said order of priority to a RAN node.

47. A non-transitory computer-readable medium comprising, stored thereupon, computer program instructions configured for execution by processor circuitry on a core network (CN) node and configured so that, when executed by said processor circuitry, the computer program instructions cause the CN node to:
determine an order of priority between different logical bearers between a radio device and the CN, said bearers having different characteristics; and
transmit a message comprising said order of priority to a RAN node.
